(19) United States
(12) Patent Application Publication
(10) Pub. No.: US 2021/0400919 A1
(43) Pub. Date: Dec. 30, 2021

(54) PET TAG THAT ATTACHES TO COLLAR THROUGH EXISTING EYELET

(71) Applicant: Scott Michael Dunlevy, Seattle, WA (US)

(72) Inventor: Scott Michael Dunlevy, Seattle, WA (US)

(21) Appl. No.: 16/946,580

(22) Filed: Jun. 27, 2020

(51) Int. Cl. A01K 27/00; A01K 11/00

(52) U.S. Cl. CPC A01K 27/006; A01K 11/00

(57) ABSTRACT

A pet tag that offers a display head with imprinted owner information that is attached directly to a collar by a bolt running through an existing eyelet on a collar. It is an inclusive tag comprising the means to attach in addition to providing pet identification information on the display head surface.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This relates to pet identification tags, specifically to pet name tags for domesticated animals (e.g. dogs), that do not make noise, do not require a specific collar or modifications to an existing collar, nor require a tool to install. Pet tags are ornamental devices designed for attachment to an animal collar that convey owner information in addition to a design element. These tags provide an important lifeline to pets by providing the contact information needed to determine ownership in case the pet is ever lost. The most common tags used today are made of metal and attach to a metal loop on the pet's collar with a metal split ring. This metal on metal contact leads to noise being produced when the tag rubs against the metal ring and the rubbing of that ring against the metal collar loop. These tags are most commonly used with dogs, and canine ears have 18 muscles to identify and capture sound. Imagine an inescapable metal on metal noise with every move you make, when you have ears naturally designed to pick up on sounds better than any other human. Animals are often considered part of a family unit, and some consideration should be given to their wellbeing and quality of life. This constant noise could also burden the owner, with the noise pollution preventing peace and quiet, possibly impacting their life if their animal's movement wakes them from sleep. An absence of noise can also be advantageous in certain settings where an animal needs to be quiet (e.g. hunting).

Pet supply companies have long searched for a way to identify a pet that does not make noise. Recently, Blizzard in U.S. Pat. No. 9,911,368 (2018) offers a solution which attempts to isolate the tag to limit the noise with a pet tag holder. This approach does not address the noise made by the friction of the metal ring against the collar's metal loop and therefore does not fully address the root problem. Another issue is this attachment adds bulk to a dangling tag that is more exposed to be lost during the course of activity, which would leave a lost dog with no way to contact the rightful owner for reunification.

Graham, in U.S. Pat. No. 3,782,017 (1974) shows a tag similar to Fassit in U.S. Pat. No. 272,036 (1883), with both tags attaching to the collar with multiple rivets. Attachment to the collar with rivets decreases the risk of loss and eliminates noise, however installation requires the use of a riveter or rivet tool. This specialty tool is not readily available to most pet owners. Even if they purchase the tool (at an additional cost) they may not have the mechanical abilities to successfully create an exact sized hole to allow for the rivet and mechanically attach the tag with the tool. In this case they would need to render the services of a tool owner also at an additional cost, and be left without their collar (needed to control the animal) while the installation occurs. Graham's tag also allows for protrusions that wrap around the collar as another means to attach the tag to the collar, but this design dictates the need for a particular width of collar. According to the American Kennel Club, dogs can range from five to two hundred pounds. One must take into account the large range of collar sizes needed for adequate control of the pet, with different tensile strengths needed depending on animal size.

The issue of fit is also evident in another popular tag style with a slit in each end of the rectangular tag to allow the collar to be thread through. Examples include U.S. Pat. No. 5,503,114 (1996) by Castagna and U.S. Pat. No. 7,225,761 (2007) by Reilly. With a single sized slit in the tag for a collar to feed through, if the collar is wider than the manufactured slit, it renders the tag useless. Castagna's tag and those similar would result in a poor fit by allowing too much movement within the slit when a narrower width collar is used for smaller animals. This tag design could also have weaker points at either end of the collar slit, where it would encounter the most stress if caught on something, and be more susceptible to breaking. Jeffers attempted resolution to the issues of varying collar widths and weak points in U.S. Pat. No. 3,585,743 (1971) shows a tag that can adjust for different collar widths, yet the acceptable collar is still limited to the width of the metal slot. Jeffers' mechanism also requires holes to be screwed into the actual collar, which requires a sharp screw and tool use. Again, pet owners may not have access to the tools or the physical strength needed for installation, nor have the desire to perform the mechanical process.

Many different approaches for identification tags have been patented that wrap around the collar to prevent the need for mechanical installation and alleviate fit concerns. Chaffin in U.S. Pat. Application No. US 2010/0242860, and LeVally in U.S. Pat. Application No. US 2007/0283901 show mechanisms that wrap around an existing collar that will attach to itself. This iteration of an identification tag allows for entry points of the elements. Dogs can vary in terms of activity level and breed function, and oftentimes animals are bred for swimming or digging holes. Issues arise with exposure to the elements during normal use, causing premature wear and possibly rendering the identification illegible. If the identification information is scribed by the owner, it likely is in less than permanent form, and the elements could jeopardize legibility over the long term. In U.S. Pat. Application No. US 2018/0049409 by Sporn, it even shows the vital identification information contained on a paper card that would not be adequately durable to withstand the elements.

Keeping with the goal of mitigating the risk of loss, preventing interference by the elements, and solving these problems with fit, solutions where collars are designed in conjunction with identification become apparent. As seen in U.S. Pat. No. 6,497,198 (2002) by Evans, it shows a collar with integrated windows for identification visibility. This design requires the entire collar be procured and the owner must already have the tag complete with information to present inside the collar. Similarly U.S. Pat. No. 5,653,197 (1997) requires collar replacement, but also requires their proprietary lettering for identification, adding to the list of items needed to procure to properly identify the pet. Multiple other solutions including U.S. Pat. No. 7,293,383 (2007) by Fishman et al., U.S. Pat. Application No. US2017/0215387 by Kadell, and U.S. Pat. Application US2013/0042821 by Roberts et al., all require the purchase of a new specialized collar. Most pet owners already own a collar to control their pet and are only looking for identification and not interested in purchasing an additional collar at an additional cost. Oftentimes they want to choose a collar based on aesthetics. If a pet owner either already owns a collar or prefers a collar design of their choice, and wants an identification tag that eliminates noise, their options are limited.

Geier in U.S. Pat. Application No. US2018/0160655 A1 shows a tag that takes advantage of the existing eyelet to make the tag more adaptable. This attachment to the collar by way of exiting eyelet is noted in paragraph 0032, but use of the eyelet hole is limited to attaching the layered item to the collar by means of fastener. As seen in FIG. 4, it shows a layered item with a pocket for holding an identification item, fitting in the open eyelet by way of fastener, but no means are provided within the design to attach the tag to the collar or provide the actual identification tag. Issues again arise with the inability to easily attach the tag, and does not provide the actual means to identify your pet if you don't already have a tag that can withstand the elements. Another issue with this design is that the layered pieces and openings allow elements to enter the tag pocket and possibly compromising the structure.

Decorative items also encounter the same issues as the identification, where it can be easily caught and lost, exposed to the elements, and may need special tools to be installed. The removable dog accessory noted in U.S. Pat. No. 9,339,015 (2016) where a single connector unlikely can withstand use of a moderately active animal. Decorative items also then look to inefficient specialty tool installation with rivets by Lin in U.S. Pat. No. 5,367,987 (1994) or require the pet owner to purchase an entire collar and leash with U.S. Pat. No. 8,142,053 (2012) by Hurwitz.

### BRIEF SUMMARY OF THE INVENTION

To address the multiple pain points of pet identification and attaching ornaments to a collar we offer the following invention. An improved pet tag has two pieces that screw together through the existing eyelet on pet collars that have an open eyelet. This method of attaching allows any sort of ornamental or informational items. Installation is easy, with the simplicity of a screw mechanism through a pre-existing hole. No specialty tools, machinery, or professional services are needed to install the tag, at most a screwdriver could be used for additional torque. Taking advantage of the existing holes in the collar, eliminates the risk of weakening the collar, as well as less room for error and injury in punching a new hole. This simple and novel approach to attaching items to a pet collar fits in most existing eyelets, eliminating the need to purchase a collar. This is a cost savings and allows the pet owner to use their collar of choice for a multitude of reasons, including aesthetics, fit, pet comfort, etc. It eliminates the need to take off the collar if it is difficult on some animals, and the tag does not need be replaced if a collar is changed, as it can simply be unscrewed and attached to a replacement collar. With no moving pieces, no noise is made. Both pieces lay flush against the collar limiting the risk of the tag catching on something reducing risk of loss. The pet identification information is imprinted on the display head surface, on the side facing away from the pet so to be easily read. The design being only two solid pieces of material, it limits the amount of pieces that can fail during use by active animals, with imprinted information on the tag to eliminate the concern for wearing off with exposure to the elements. This system allows the purchase without needing to know what collar a pet may have, only needing to know if there are eyelets.

### BRIEF DESCRIPTION OF THE SEVERAL VIEWS OF THE DRAWINGS

FIG. 1 is a side view and perspective view of a pet tag in accordance with the invention, showing the two pieces, according to an embodiment of the invention.

FIG. 2 is an exploded view showing the method to attach to collar, according to an embodiment of the invention.

FIG. 3 is a front perspective view of the tag in use and attached to collar, according to an embodiment of the invention.

FIG. 4 is a cross-sectional view of the pet tags of FIGS. 1-2, according to an embodiment of the invention.

FIG. 5 is perspective and side view of a second embodiment of the tag with different display heads in FIGS. 1-4, according to an embodiment of the invention.

FIG. 6 is a front and back view of display head of FIGS. 1-5, according to an embodiment of the invention.

FIG. 7 is a top view of additional bolt head embodiments of FIGS. 1-5, according to an embodiment of the invention.

### DETAILED DESCRIPTION OF THE INVENTION

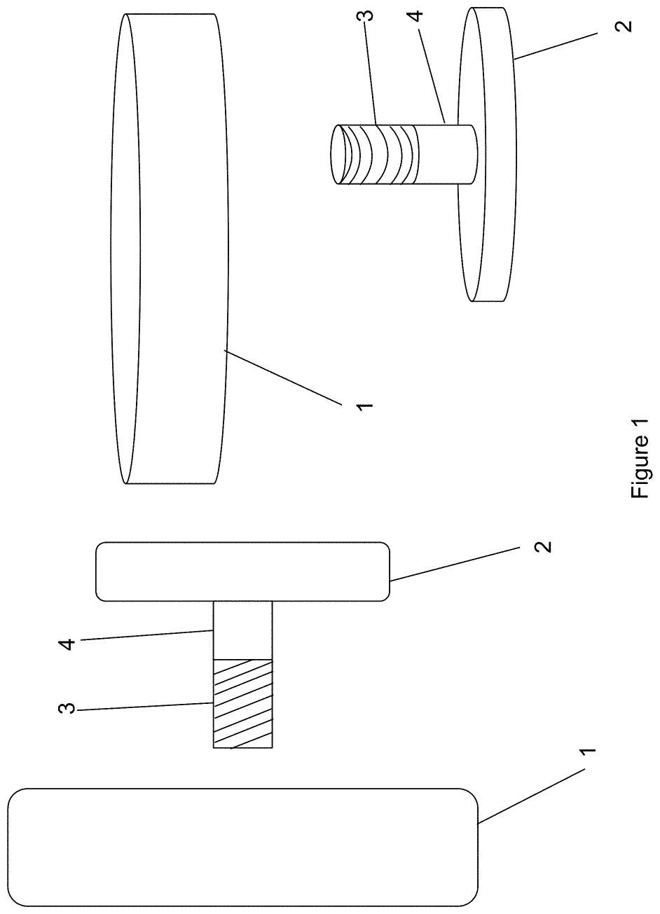

FIG. 1 is a side view and perspective view from the side of a display head 1 and bolt head 2 in accordance with one embodiment, will contain male threads 3 on post to fit female threads in display head 1. This embodiment shows a blank unthreaded portion of the bolt post 4, but the post may be entirely threaded. The blank portion of post 4 may allow the entire tag to freely spin once joined together limiting risk it may loosen by reducing friction.

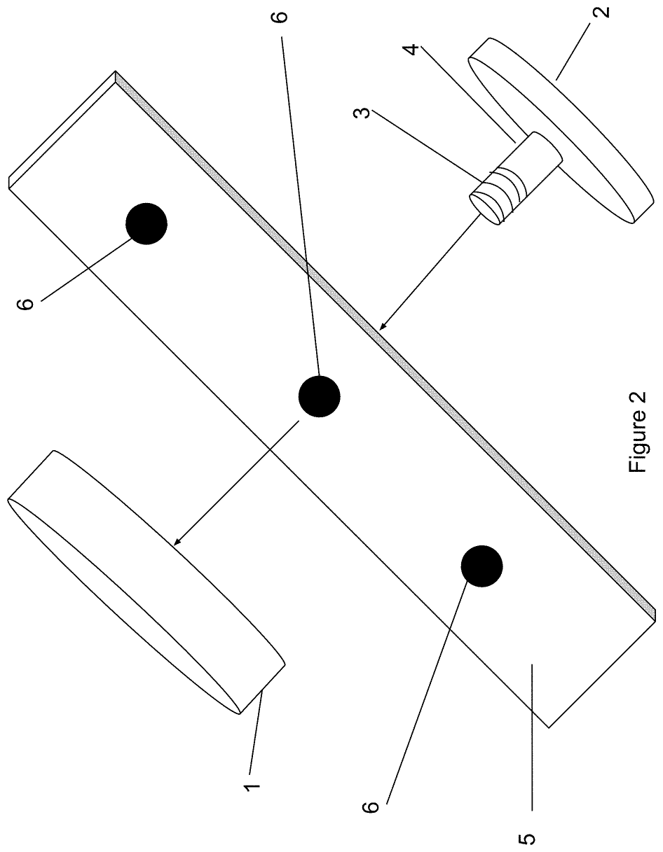

FIG. 2 is an exploded view showing bolt 2 threading from the bottom of the collar 5 through the collar eyelet 6 into the display head 1.

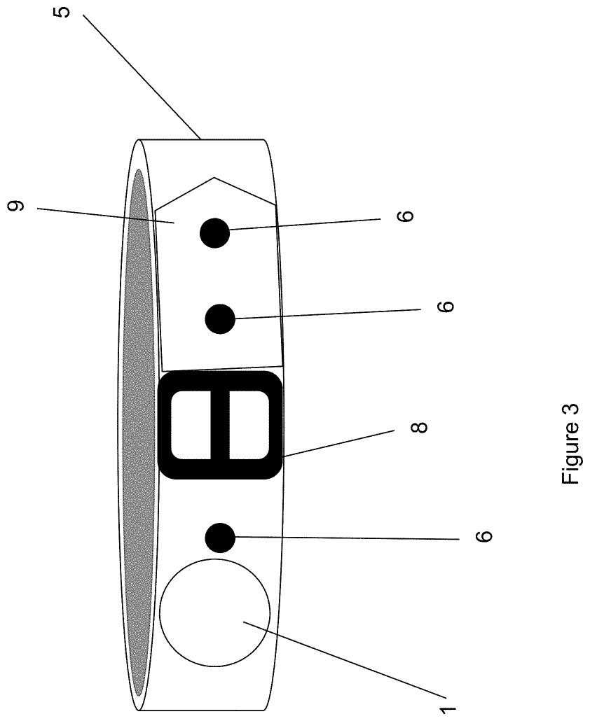

FIG. 3 is a front perspective view of the display head 1 attached to the collar by way of the existing open eyelet 6 that was produced when the collar 5 was originally manufactured. Collars that have a buckle 8 are designed with multiple eyelets 6 to allow adjustment for different sized animals.

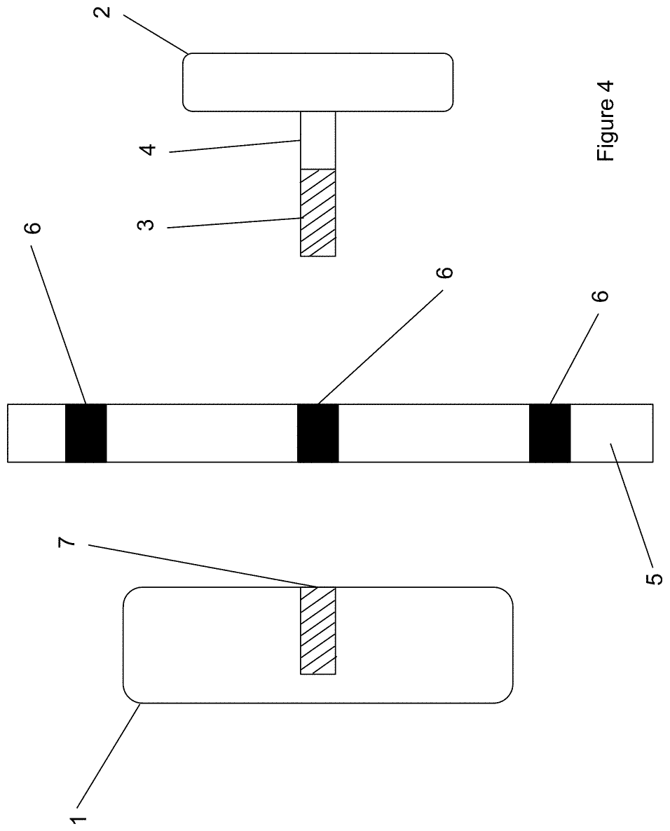

FIG. 4 shows a cross-sectional view with orientation of the bolt head 2 and post 3 to open eyelet 6 in collar 5 to the display head 1. It shows the female threads 7 to accommodate the threaded post 3.

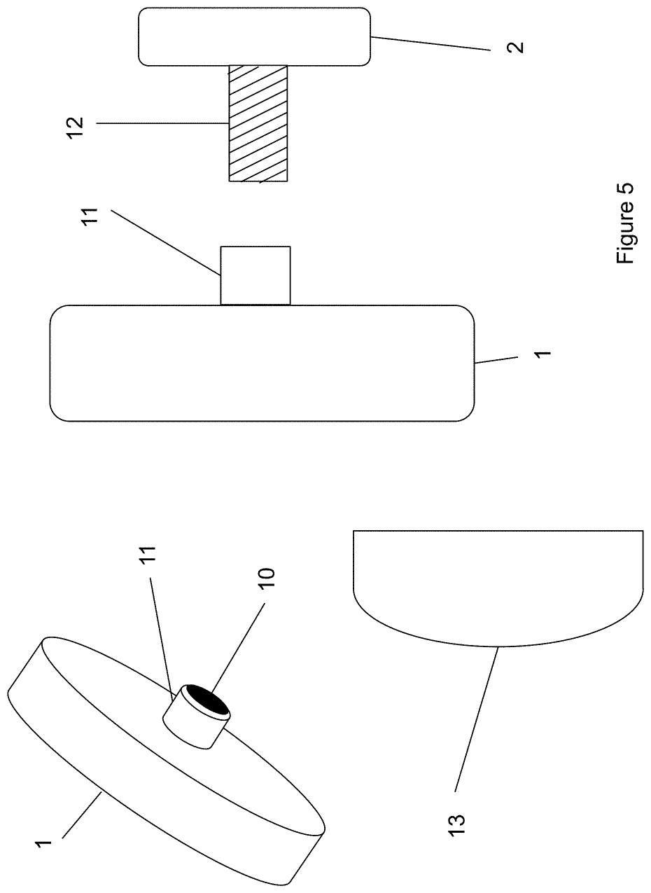

FIG. 5 shows multiple other embodiments of the display head 1 and bolt post 12. A lip 11 on the display head 1 also accomplishes the goal of a smooth surface against the collar eyelet 6 to prevent friction. With more room for female thread in the lip 11, the threaded cavity 10 would not have to run as deep into the display head 1 and therefore allow the display head to be thinner and use of a shorter post 12. The display head 1 could allow for different shapes, not limited to but including a more rounded surface 13.

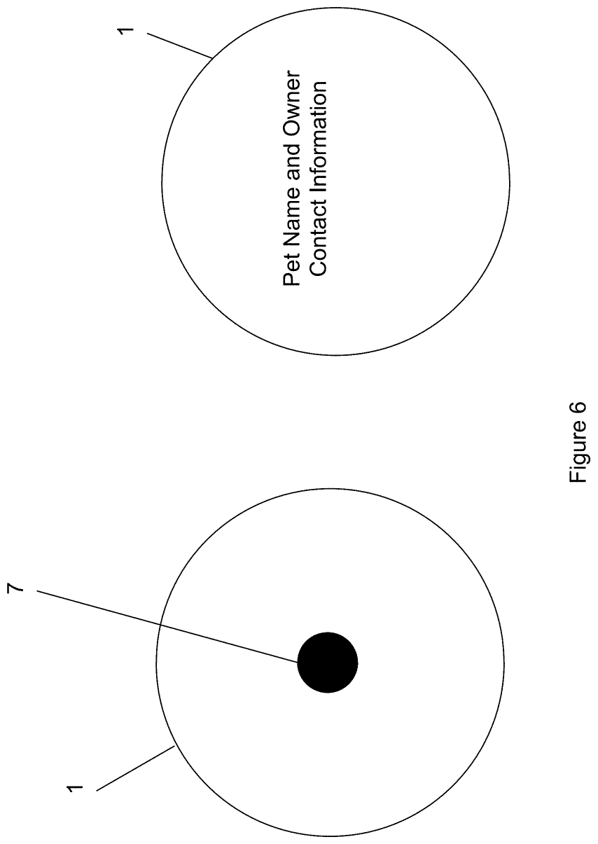

FIG. 6 shows a top and bottom view of the display head 1 in FIG. 1-4. The bottom view showing the female thread 7 portion of the display head 1, in addition to an example of the information one would see on the display head 1. The female threads 7 not running through the face allows for a clean surface to display information in this embodiment.

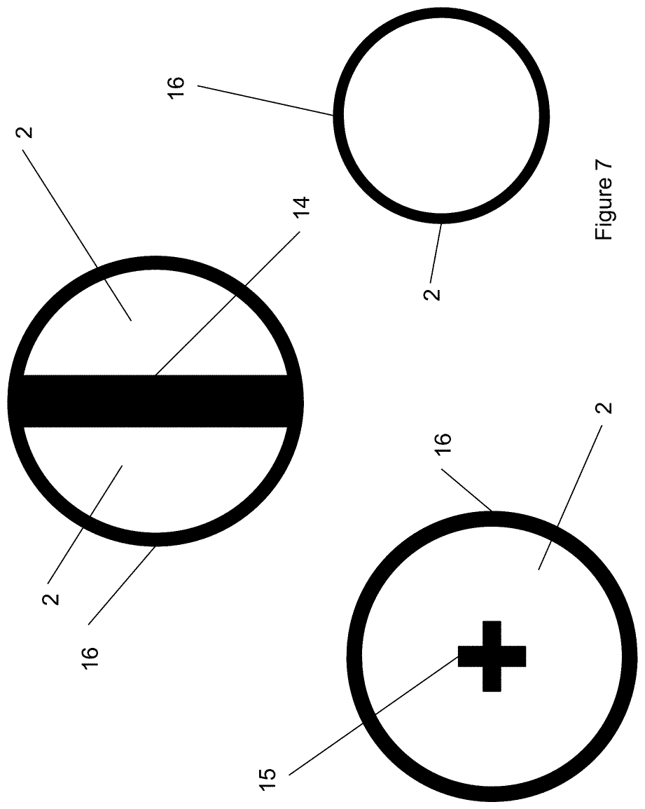

FIG. 7 shows multiple other embodiments of the bolt head 2. The bolt head 2 used can be a general purpose bolt accommodating a flat head or Phillips head screwdriver individually, or in addition allow for a knurled head 16 to eliminate the need for tools to install. The bolt could also allow a slot for flat head screwdriver 14 or Phillips head 15 in addition to a knurled head 16, which allows for hand tightening with no tools necessary, but will also accommodate a screwdriver for added torque.

### REFERENCE NUMERALS

1 display head
2 bolt head
3 threaded bolt post
4 unthreaded portion of bolt post
5 collar
6 collar eyelet
7 female thread
8 collar buckle
9 excess collar material after cinched
10 threaded cavity
11 display head lip
12 fully threaded bolt post
13 display head
14 driver slot
15 driver slot
16 knurled head

### Operation

The two pieces consist of a male and female thread, not dissimilar to a bolt and nut. These pieces can be interchangeable as long as both the bolt head and display head have a greater diameter than the eyelet, there is sufficient display area to hold a character or symbol and male and female threads are present. These two pieces thread together, sandwiching the collar, using a post that runs through the existing collar eyelet. The display head is specially designed for this use to allow a flat face which allows a clean and even letter stamp and imprint, but may be different shapes as long as can accept a stamped or printed symbol on the surface. These characters in the current form are imprinted with a metal stamping machine, on one or both pieces. The initial iteration will be a brass alloy, it can vary in terms of materials, including man made, natural, and synthetic. The bolt used is a size four traditional bolt post which fits through most existing eyelets, but the design allows for the post to be thicker or narrower. The current iteration is a Phillips bolt head, however pieces could be specifically manufactured for the sole purpose intended. The item may include a thread locking material to prevent coming loose.

### Ramifications

Additional ramifications of the idea may include companies advertising their company name, slogan, and contact information. The information could include licensed information, such as sport team endorsements. Novelty products could also be a use of the design, such as common nicknames for pets, breed of the animal, or any writing including sensical and nonsensical. A ramification could include only a design element and convey no information. Both pieces can have variations of size to convey different information, fit different collars and serve different purposes.

The claimed invention is:

1. A pet tag comprising:
a display head that lays atop a collar that can contains information on a surface;
means for attaching said display head to said collar through a single preexisting collar eyelet;
whereby pet identification information is attached to a collar.
